(19) United States
(12) Patent Application Publication
(10) Pub. No.: US 2004/0151831 A1
(43) Pub. Date: Aug. 5, 2004

(54) Rapid on-site vehicle paint repair system and method therefor

(76) Inventor: Jacob L. Begis, Edmonds, WA (US)

Correspondence Address: WEISS & MOY PC, 4204 NORTH BROWN AVENUE, SCOTTSDALE, AZ, 85251, US

(21) Appl. No.: 10/357,034

(22) Filed: Jan. 31, 2003

(51) Int. Cl. B05D 1/36

(52) U.S. Cl. 427/140; 427/542; 427/402; 427/372.2; 118/300

(57) ABSTRACT

A method for a rapid on-site repair of paint and finish damage to a vehicle is comprises: preparing a surface area to be repaired; preheating the surface area to be repaired; applying paint to preheated surface while maintaining a surface temperature of the surface area at a predetermined level; and drying the paint applied to the surface area.

### RELATED APPLICATIONS

This patent application is claiming the benefit of the U.S. Provisional Application having an application number of ______, filed Jan. 31, 2002, in the name of Jacob L. Begis, and entitled “ON-SITE AUTO BODY AND PAINT REPAIR PROCESS”.

### BACKGROUND OF THE INVENTION

1. Field of the Invention

This invention relates generally to vehicular repairs and, more specifically, to a system and method for the rapid on-site repair of paint and finish damage to vehicles such as automobiles, trucks, motorcycles, aircraft, and the like.

2. Description of the Prior Art

Almost everyone who owns a vehicle has been in an accident at one time or another. Most vehicles that are involved in an accident will receive some type of damage. Generally the damage caused during minor accidents is related to scratched paint on the bumper and/or body of the vehicle. Whether the paint damage is extensive or minimal most people would prefer to fix the damage. Unfortunately, at the present time, to repair paint and finish damage to a vehicle is a time consuming process.

In order to repair paint and finish damage to a bumper and/or body of a vehicle, one must take the vehicle to a paint and body repair shop. The owner must leave the vehicle at the repair shop for one or more days while the vehicle is being repaired. While at the repair shop, the damaged area is prepared. Proper surface preparation is a critical first step in any paint repair job. If surface rust, road film, tar, wax, silicone, moisture, salt and the like are not removed, the touch-up paint will separate from the surface and create a pocket that wicks in moisture and accelerates destruction of the steel panel and blistering of surrounding paint. Moreover, if the surrounding paint is not sufficiently “scuffed,” the touch-up paint will not adhere at the edges of the repair, again creating a separation that traps moisture and accelerates deterioration of the paint and substrate. Once the area is prepared, the damaged area may be painted. A primer layer is generally laid first. Once a primer layer is applied, one or more layers of paint are—applied to the treated damaged area.

The above process is fairly expensive and time consuming. As stated above, one generally has to leave the vehicle at the repair shop for one or more days. There are less expensive and less time consuming ways to repair paint and finish damage to a vehicle. For example, U.S. Pat. No. 5,730,644 and U.S. Pat. No. 6,142,868 describe a repair kit to facilitate a quick and durable paint repair on a vehicle or other painted item. The problem with these types of kits are that the quality of the repair is generally fairly poor. Furthermore, the kits generally only allow one to fix small scrapes to the vehicle.

Therefore, a need existed to provide an improved system and method to repair paint and finish damage to a vehicle. The improved system and method will prove a mobile solution to the repair of paint and finish damage to a vehicle. The improved system and method will prove a less time consuming solution to the repair of paint and finish damage to a vehicle.

### SUMMARY OF THE INVENTION

In accordance with one embodiment of the present invention, it is an object of the present invention to provide an improved system and method to repair paint and finish damage to a vehicle.

It is another object of the present invention to provide an improved system and method that will prove a mobile solution to the repair of paint and finish damage to a vehicle.

It is still another object of the present invention to provide an improved system and method that will prove a less time consuming solution to the repair of paint and finish damage to a vehicle.

### BRIEF DESCRIPTION OF THE EMBODIMENTS

In accordance with one embodiment of the present invention, a method for a rapid on-site repair of paint and finish damage to a vehicle is disclosed. The method comprises: preparing a surface area to be repaired; preheating the surface area to be repaired; applying paint to preheated surface while maintaining a surface temperature of the surface area at a predetermined level; and drying the paint applied to the surface area.

In accordance with another embodiment of the present invention, a method for a rapid on-site repair of paint and finish damage to a vehicle is disclosed. The method comprises: preparing a surface area to be repaired by sanding the surface area to be repaired; preheating the surface area to be repaired by heating the surface area to be repaired with a heating element to approximately 60 t 120 degrees Fahrenheit; applying a base coat to the preheated surface while maintaining a surface temperature of the surface area at a predetermined level; applying a clear coat to the preheated surface while maintaining the surface temperature of the surface area at the predetermined level; and drying the paint applied to the surface area.

In accordance with another embodiment of the present invention, a vehicle for rapid on-site repair of paint and finish damage to a vehicle is disclosed. The vehicle comprises a transport vehicle. A portable generator is stored on the transport vehicle. A portable protective cover is stored on the transport vehicle. A compressor system is coupled to the portable generator and stored on the transport vehicle. A paint gun is coupled to the compressor system and stored on the transport vehicle. A sander is coupled to the portable generator and stored on the transport vehicle. A heating element is coupled to the portable generator and stored on the transport vehicle. A plurality of toners of base coat paints are stored on the transport vehicle.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is a flow chart depicting a method for a rapid on-site repair of paint and finish damage to a vehicle.

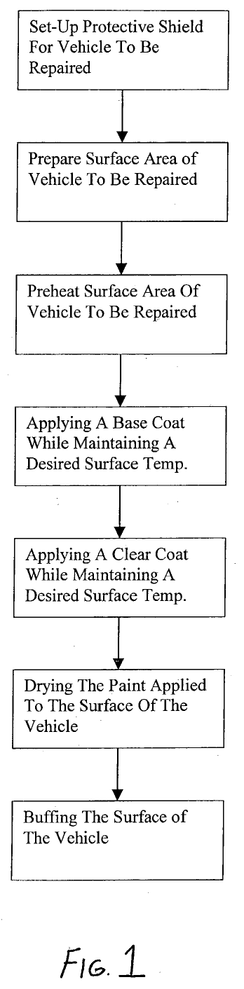

FIG. 2 is a block diagram depicting a vehicle for rapid on-site repair of paint and finish damage to a vehicle.

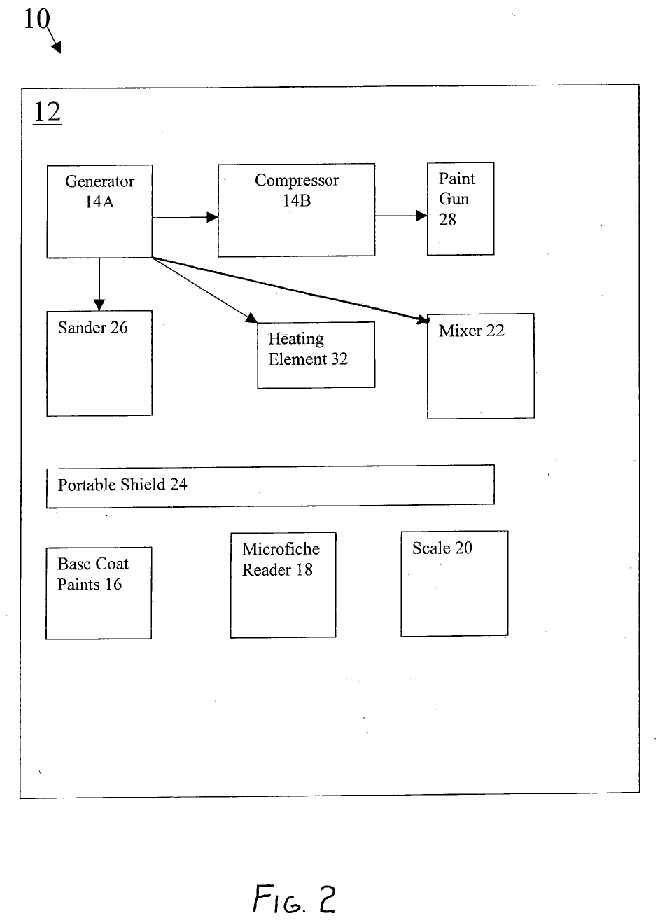

### DETAILED DESCRIPTION OF THE PREFERRED EMBODIMENT

Referring to the Figures, wherein like numerals and symbols represent like elements, a system 10 is shown for the repair of paint and finish damage to an object. In general, the system 10 is used to repair paint and finish damage to a vehicle such as automobiles, trucks, motorcycles, aircraft, and the like.

The system 10 uses a transport vehicle 12. The transport vehicle 12 is used to transfer the equipment necessary for the on-site repair of paint and finish damage to a vehicle. The transport vehicle 12 may be a pick-up truck, van, or the like. It should be noted that the above are only given as examples and should not be seen as to limit the scope of the present invention.

The transport vehicle 12 will have a generator 14A and compressor 14B. The generator 14A is used to power equipment used for the repair of paint and finish damage to a vehicle. A 5000 watt generator 14A should be of sufficient size. However, larger and smaller generators may be used. The compressor 14B is generally coupled to the generator 14A. The compressor 14B is used to dispense paint in order to repair paint and finish damage to a vehicle. In accordance with one embodiment of the present invention, a 15 gallon, 4.5 hp compressor 14B is used. In general, the generator 14A is a portable self powered units. In accordance with one embodiment of the present invention, a gas powered generator 14A is used. The generator 14A and the compressor 14B are generally compartmentalized in the transport vehicle 12 and vented.

The transport vehicle 12 will carry a plurality of different tones of base coat paint 16. The base coat paint 16 may be combined and mixed to produce different colors to match the paint color of a vehicle that is being repaired. The transport vehicle 12 will generally carry approximately 60 toners of base coat paint 16. In general, the different toners should be stored in small containers so that the toners may be positioned within a cabinet within the transport vehicle 12.

In order to properly match the paint color of the vehicle to be repaired, the transport vehicle 12 will carry microfiche reader 18. The microfiche reader 18 is used to read paint formulas so that one is able to mix different base coat paints 16 to produce different colors to match the paint color of a vehicle that is being repaired. A small scale 20 and mixer 22 are used to properly prepare and mix the different base coat paints 16 which are required. The microfiche reader 18, the small scale 20 and mixer 22 may be battery powered or coupled to the generator and compressor system 14. Other power sources may be used to power the above devices without departing from the spirit and scope of the present invention.

A portable shield 24 is stored within the transport vehicle 12. The portable shield 24 is a collapsible shield which is erected when work is to be done. The portable shield 24 is of sufficient size to protect the vehicle to be repaired from the environments. In some areas, a paint shield is required in order to obtain a permit for mobile refinishing. The portable shield 24 will satisfy these requirements.

Before the damaged area can be repainted, the area on the vehicle to be repaired needs to be prepared. A sander 26 is used to prepared the damaged area. The sander 26 is generally an electrical sander which is coupled to the generator 14A.

A paint gun 28 is coupled to the compressor 14B via an air hose 30. The paint gun 28 is usually a high volume low pressure (HVLP) gravity fed paint gun 28 since these are easier to clean-up. A coil type air hose 30 is generally used to couple the compressor 14B to the paint gun 28 with a water trap to cool air and reduce water problems due to the heat of the generator 14A and compressor 14B operating in a confined space of the transport vehicle 12. The paint gun 28 is used to apply a base coat and a clear coat to the treated damaged area of the vehicle. A heating element 32 is used to preheat the area to be repaired. In general a heat gun or infrared light is used. The heating element 32 is used to preheat the area between 60 to 120 degrees Fahrenheit.

The base coat and clear coat are sprayed while using the concurrent heat of the heating element 32 in the spray pattern of the paint gun 28. As stated above, the heating element 32 is used to maintain the surface temperature at approximately 60-120 degrees Fahrenheit. The clear coat should be a fast drying clear coat for outdoor repairs. For example, Dupont 4700 clear coat would work well. The heating element 32 will be necessary for temperatures below 50 degrees Fahrenheit since clear coats are designed for use over 60 degrees Fahrenheit and in auto body shops. To dry clear coat, the surface must be preheated with the heating element 32.

The heating element 32 is held in the spray pattern of the paint gun 28 as the different coats are applied to keep the surface hot. After the coats are applied, the heating element 32 is run over the painted area. The length of time the heating element 32 is run over the painted area will vary on the outside temperature. In general, the heating element 32 should be run over the surface of the vehicle for approximately 10 minutes. The colder the temperature and the time of day will determine how long the on-site drying process should be applied. The best indicator of when the paint drying is the change in odor emanating from the freshly painted surface.

If the clear coat is maintained at 120 degrees Fahrenheit for 10 minutes, the vehicle may be puled out from underneath the portable shield 24 after a 20 minute cool down. Rain or other elements will not cause blushing or spotting problems. Since a heating element 32 will not generally tell one when the surface temperature is 120 degrees Fahrenheit, the odor test is generally the only way to gauge whether the paint is dry. Once the paint is dry, a buffer 34 may be used to polish the finished surface.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A method for a rapid on-site repair of paint and finish damage to a vehicle comprising:
preparing a surface area to be repaired;
preheating the surface area to be repaired;
applying paint to preheated surface while maintaining a surface temperature of the surface area at a predetermined level; and
drying the paint applied to the surface area.

2. A method for a rapid on-site repair of paint and finish damage to a vehicle in accordance with claim 1 wherein the step of preparing a surface area to be repaired further comprises sanding the surface area to be repaired.

3. A method for a rapid on-site repair of paint and finish damage to a vehicle in accordance with claim 1 wherein the step of preheating the surface area to be repaired comprises heating the surface area to be repaired with a heating element to approximately 60 t 120 degrees Fahrenheit.

4. A method for a rapid on-site repair of paint and finish damage to a vehicle in accordance with claim 3 wherein the heating element is a heating gun.

5. A method for a rapid on-site repair of paint and finish damage to a vehicle in accordance with claim 3 wherein the heating element is am infrared light.

6. A method for a rapid on-site repair of paint and finish damage to a vehicle in accordance with claim 1 wherein the step of applying paint to preheated surface while maintaining a surface temperature of the surface area at a predetermined level comprises the steps of:
applying a base coat to the preheated surface while maintaining a surface temperature of the surface area at a predetermined level; and
applying a clear coat to the preheated surface while maintaining the surface temperature of the surface area at the predetermined level.

7. A method for a rapid on-site repair of paint and finish damage to a vehicle in accordance with claim 6 wherein a heating element is used for maintaining the surface temperature of the surface area at approximately 60 t 120 degrees Fahrenheit.

8. A method for a rapid on-site repair of paint and finish damage to a vehicle in accordance with claim 1 wherein drying the paint applied to the surface area comprises heating the surface area at approximately 120 degrees Fahrenheit.

9. A method for a rapid on-site repair of paint and finish damage to a vehicle in accordance with claim 8 wherein drying the paint applied to the surface area further comprises heating the surface area at approximately 120 degrees Fahrenheit for at least approximately 10 minutes.

10. A method for a rapid on-site repair of paint and finish damage to a vehicle in accordance with claim 1 further comprising buffing the surface area to be repaired after the paint applied to the surface area has dried.

11. A method for a rapid on-site repair of paint and finish damage to a vehicle in accordance with claim 1 further comprising providing a mobile paint vehicle for the rapid on-site repair of paint and finish damage to a vehicle.

12. A method for a rapid on-site repair of paint and finish damage to a vehicle in accordance with claim 11 wherein providing a mobile paint vehicle for the rapid on-site repair of paint and finish damage to a vehicle further comprises:
providing a portable generator;
providing a protective cover;
providing a compressor system coupled to the portable generator;
providing a paint gun coupled to the compressor system;
providing a sander coupled to the portable generator;
providing a heating element coupled to the portable generator; and
providing a plurality of toners of base coat paint.

13. A method for a rapid on-site repair of paint and finish damage to a vehicle in accordance with claim 11 wherein providing a mobile paint vehicle for the rapid on-site repair of paint and finish damage to a vehicle further comprises:
providing a scale;
providing a microfiche reader; and
providing a buffer.

14. A method for a rapid on-site repair of paint and finish damage to a vehicle comprising:
preparing a surface area to be repaired by sanding the surface area to be repaired;
preheating the surface area to be repaired by heating the surface area to be repaired with a heating element to approximately 60 t 120 degrees Fahrenheit;
applying a base coat to the preheated surface while maintaining a surface temperature of the surface area at a predetermined level;
applying a clear coat to the preheated surface while maintaining the surface temperature of the surface area at the predetermined level; and
drying the paint applied to the surface area.

15. A method for a rapid on-site repair of paint and finish damage to a vehicle in accordance with claim 14 wherein the heating element is used for maintaining the surface temperature of the surface area at approximately 60 t 120 degrees Fahrenheit.

16. A method for a rapid on-site repair of paint and finish damage to a vehicle in accordance with claim 15 wherein drying the paint applied to the surface area comprises heating the surface area at approximately 120 degrees Fahrenheit with the heating element.

17. A method for a rapid on-site repair of paint and finish damage to a vehicle in accordance with claim 16 wherein drying the paint applied to the surface area further comprises heating the surface area at approximately 120 degrees Fahrenheit for at least approximately 10 minutes.

18. A method for a rapid on-site repair of paint and finish damage to a vehicle in accordance with claim 14 further comprising buffing the surface area to be repaired after the paint applied to the surface area has dried.

19. A method for a rapid on-site repair of paint and finish damage to a vehicle in accordance with claim 14 further comprising:
setting up a portable protective cover; and
placing the vehicle under the portable protective cover.

20. A method for a rapid on-site repair of paint and finish damage to a vehicle in accordance with claim 14 further comprising providing a mobile paint vehicle for the rapid on-site repair of paint and finish damage to a vehicle.

21. A method for a rapid on-site repair of paint and finish damage to a vehicle in accordance with claim 20 wherein providing a mobile paint vehicle for the rapid on-site repair of paint and finish damage to a vehicle further comprises:
providing a portable generator;
providing the portable protective cover;
providing a compressor system coupled to the portable generator;
providing a paint gun coupled to the compressor system;
providing a sander coupled to the portable generator;
providing a heating element coupled to the portable generator; and
providing a plurality of toners of base coat paint.

22. A method for a rapid on-site repair of paint and finish damage to a vehicle in accordance with claim 21 wherein providing a mobile paint vehicle for the rapid on-site repair of paint and finish damage to a vehicle further comprises:
providing a scale;
providing a microfiche reader; and
providing a buffer.

23. A vehicle for rapid on-site repair of paint and finish damage to a vehicle comprising:
a transport vehicle;
a portable generator stored on the transport vehicle;
a portable protective cover stored on the transport vehicle;
a compressor system coupled to the portable generator and stored on the transport vehicle;
a paint gun coupled to the compressor system and stored on the transport vehicle;
a sander coupled to the portable generator and stored on the transport vehicle;
a heating element coupled to the portable generator and stored on the transport vehicle; and
a plurality of toners of base coat paint stored on the transport vehicle.

24. A vehicle for rapid on-site repair of paint and finish damage to a vehicle in accordance with claim 23 further comprising:
a scale stored on the transport vehicle;
a microfiche reader stored on the transport vehicle; and
a buffer coupled to the portable generator and stored on the transport vehicle.
